(19) United States
(12) Patent Application Publication
(10) Pub. No.: US 2010/0277022 A1
(43) Pub. Date: Nov. 4, 2010

(54) ELECTRICAL GENERATING SYSTEM, "CROSS-OVER SYSTEM" TO GENERATE ELECTRICAL ENERGY AS THE DRIVING POWER OF LAND VEHICLES WITH AN ELECTRICAL ENGINE/MOTOR AS THE VEHICLES MOTOR

(76) Inventor: Andrej A. SAZEPIN, Neu-Ulm (DE)

Correspondence Address: LADAS & PARRY LLP, 26 WEST 61ST STREET, NEW YORK, NY, 10023, US

(21) Appl. No.: 12/765,342

(22) Filed: Apr. 22, 2010

(30) Foreign Application Priority Data
Apr. 29, 2009 (DE) 102009019421.5-32

(51) Int. Cl. H02K 47/14; H02K 53/00

(52) U.S. Cl. 310/113; 415/916

(57) ABSTRACT

Innovative self-sustaining/self-supportive electrical-generating system to produce electrical energy, to power land vehicles with an electrical engine/motor, characterized, that this land vehicle can run without any fossil raw material and that rotational energy from motion of the vehicle is converted into electrical energy that can be stored by a battery/energy cell and power the electrical engine/motor by means of a generator.

### FIELD OF THE INVENTION

Today's internal combustion engines are all known to need some kind of fossil raw material to fuel/power their engines/motors, and that causes considerable CO₂/greenhouse gas output. The present invention provides propulsion for a land vehicle while avoiding the use of such fossil fuels.

### BACKGROUND OF THE INVENTION

The present invention aims to solve the problem of how to reduce the large number of internal combustion engines and at the same time not only simplify the generation of electrical energy as the driving power of land vehicles with an electrical engine/motor but also to clearly increase the mileage of these vehicles. That is why I developed a system that takes the existing rotation energy (kinetic energy) of the axle/drive shaft through a transmission into a generator to produce electrical energy to power the electrical engine/motor.

U.S. Pat. No. 7,416,039 (Anderson et al issued Aug. 26, 2008) describes a regenerative self-propelled vehicle which includes an energy reservoir provided by a battery-mass flywheel having a diameter approximately equal to the vehicle lateral wheel spacing, allowing a compact configuration. The flywheel may include a pair of counter rotating wheels mounted on concentric shafts and may be enclosed in a containment device.

U.S. Patent Publication 2002/0070692 (Gonzales published Jun. 13, 2002) describes an electromagnetic automotive system which includes an alternator that can be used to convert rotational kinetic energy into electric current. The alternator can be connected to a battery.

### SUMMARY OF THE INVENTION

The present invention provides propulsion for a land vehicle. The system is self-sustaining/self-supportive and can be built/constructed out of already existing components. Furthermore, if compared with conventional vehicles there is not even a considerable increase in weight because other parts can be dropped.

### BRIEF DESCRIPTION OF THE DRAWING

FIG. 1 shows schematically a system according to the present invention.

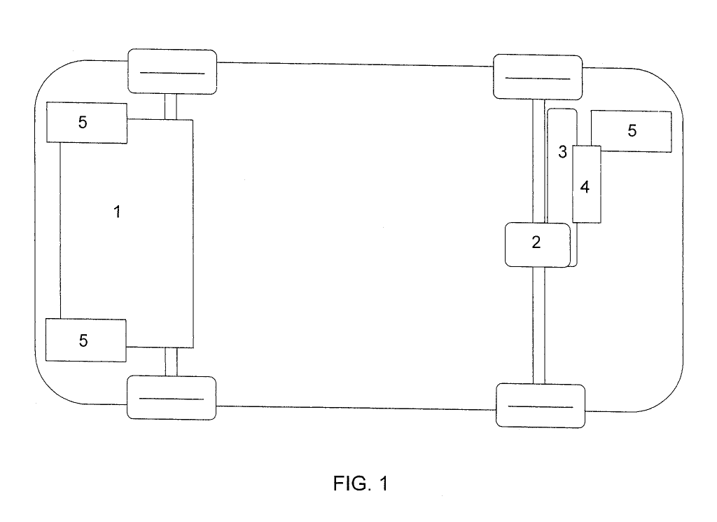

### DESCRIPTION

Electrical generating system to generate electrical energy as the driving power of land vehicles with an electrical engine/motor as the vehicles motor. According to the invention, rotational kinetic energy from the axles or drive shaft is converted into electrical energy by a generator and fed to a battery/electrical storage device that can be used to power an electric motor to drive power the vehicle.

The electrical engine (1) as the vehicle's driving power is started thought the battery/energy cell (5). The vehicle may be started by taking power from the battery. The rotational energy from the axle/drive shaft (alternative axle-transmission) sets the transmission/differential (2) into motion, thus setting the generator (3) in rotation.

The electrical energy produced from the generator (3) is conducted through a switch-/control system (4) (including transformer, converter) where it is stepped down (example: from 380V to 12V) to provide the required electrical energy for the electrical engine/motor (1) and to also recharge the battery/energy cell (5).

Through its self-sustaining/self supportive system the “CROSS-OVER System” and the recharging of the battery/energy cell (5) of the system itself is environmentally friendly, and because all of the required parts, in there different specifications already exist, the price can be easily be estimated.

It must also be mentioned that an electrical engine, when compared with an internal combustion engine, needs much less maintenance and needs no fossil raw materials.

The type of vehicle determines the number of required batteries/energy cells (5).

Vehicles according to the invention may require charging of the battery/electrical storage device from an external power source from time to time but the recapture of rotational energy will reduce the frequency at which this is required as compared to an electric vehicle lacking the energy recapture device of the present invention.

What is claimed is:

1. Innovative self-sustaining/self-supportive electrical-generating system to produce electrical energy, to power land vehicles with an electrical engine/motor, characterized, that this land vehicle can run without any fossil raw material and that rotational energy from motion of the vehicle is converted into electrical energy that can be stored by a battery/energy cell and power the electrical engine/motor by means of a generator.

2. A self-sustaining/self-supportive electrical generating system as claimed in claim 1, wherein a battery/energy cell is employed to start the system and keep the vehicle operational (traffic lights/traffic jam).
